(19) United States
(12) Patent Application Publication
(10) Pub. No.: US 2026/0346742 A1
(43) Pub. Date: Nov. 5, 2026

(54) WIRELESS CHARGING OF DIFFERENT TYPES OF ELECTRIC VEHICLES

(71) Applicant: CAPACTECH LIMITED, Kingston upon Thames, Surrey (GB)

(72) Inventor: Dorian VARGAS-REIGHLEY, Kingston upon Thames, Surrey (GB)

(73) Assignee: CAPACTECH LIMITED, Kingston upon Thames, Surrey (GB)

(21) Appl. No.: 19/487,595

(22) PCT Filed: May 30, 2024
(86) PCT No.: PCT/EP2024/064966

§ 371 Date: Nov. 25, 2025

(30) Foreign Application Priority Data
May 30, 2023 (EP) 23176229.5
Nov. 9, 2023 (GB) 2317194.5

(51) Int. Cl. B60L 53/122; B60L 53/30; B60L 53/62; B60L 53/66; H02J 50/10; H02J 50/40; H02J 50/80

(52) U.S. Cl. CPC B60L 53/122; B60L 53/30; B60L 53/62; B60L 53/66; H02J 50/10; H02J 50/40; H02J 50/80; B60L 2210/30; B60L 2210/44

(57) ABSTRACT

There is a wireless electric vehicle charging system having: (a) a modular converter or modular inverter having a plurality of modules each configured to receive power from a power source and to output power in the form of alternating current, and (b) a plurality of transmitters each configured to receive power from the modular converter/inverter and to wirelessly transmit power. Each module is switchable between: (i) a first module mode and (ii) a second module mode. Each transmitter is switchable between: (iii) a first transmitter mode and (iv) a second transmitter mode.

### CROSS-REFERENCE TO RELATED APPLICATIONS

The present application claims priority on International Application No. PCT/EP2024/064966, filed May 30, 2024, which claims priority on Great Britain Application No. 2317194.5, filed Nov. 9, 2023, and EP Application No. 23176229.5, filed May 30, 2023, the disclosure of which are incorporated herein in their entireties.

### FIELD OF THE DISCLOSURE

The present disclosure relates to wireless electric vehicle charging systems, to power management systems, modular converters, modular inverters, and transmitters for use in such wireless electric vehicle charging systems, to vehicle parks comprising such wireless electric vehicle charging systems, to use of power management systems, modular converters, modular inverters, and transmitters in such wireless electric vehicle charging systems, and to methods of charging batteries of electric vehicles parked at transmitters of such wireless electric vehicle charging systems.

In particular, the disclosure relates to a wireless electric vehicle charging system comprising switchable modules and transmitters which can respectively output and receive power in different modes, as well as to components therefor and to methods of charging electric vehicles using the same.

### DESCRIPTION OF THE RELATED ART

Wireless electric vehicle charging systems are known in the art and comprise a power source/supply, a converter or inverter, and a transmitter connected to the converter/inverter via a cable. The converter/inverter is configured to receive power from the power source/supply and to output power in the form of alternating current at a frequency of about 85 kHz to the transmitter via the cable. The transmitter is in the form of a coil and thus, when current from the converter/inverter is passed through this coil, a magnetic field is generated around the transmitter. This magnetic field can induce an alternating current in a corresponding receiver, which may also be a coil, in an electric vehicle parked at the transmitter, and this alternating current can then be rectified to direct current by a rectifier of the electric vehicle and then used to charge the battery of the electric vehicle.

Such wireless electric vehicle charging systems are installed in vehicle parks, such as car parks. In these vehicle parks, there is usually one transmitter installed in each parking space such that each electric vehicle parked in the vehicle park receives power from one transmitter only. Thus, the transmitters are positioned about 2-3 m apart from each other in the vehicle park, such as in the centre of each parking space.

Given that the transmitters need to be installed about 2-3 m apart from each other, the above-described wireless electric vehicle charging systems have one-to-one structures. This means that there is only one transmitter connected to each converter/inverter. These systems have one-to-one structures because power must be transmitted at a high frequency, such as about 85 kHz, in these systems to generate a sufficiently large magnetic field around the transmitter when the system is in use. Using such a high frequency typically generates a very high impedance in the cable used to supply power from the converter/inverter to the transmitter; it will be appreciated that this is due to the relatively high skin effect and inductive reactance generated at high frequencies. As a result of the high impedance, the cables used in these systems exhibit high power losses and voltage losses along their lengths, which means these cables need to be as short as is reasonably possible to ensure that the power reaching the transmitter is sufficient for a desired rate of charging of the electric vehicle parked at the transmitter. Thus, many existing wireless electric vehicle charging systems use a cable that is only 2-3 m in length, which means only one transmitter can typically be connected to each converter/inverter to enable the transmitters to be spaced about 2-3 m apart from each other in the vehicle park.

Using one-to-one systems is problematic because one converter/inverter needs to be installed at each parking space in the vehicle park to enable a transmitter connected thereto to be positioned at the centre of the parking space. This increases the risk of a driver of an electric vehicle driving into, and thus damaging, a converter/inverter, as well as the risk of one or more of the converters/inverters being vandalised. This also increases the cost of installing such wireless electric vehicle charging systems since a greater number of electrical components is needed.

To address the above problems, one-to-many wireless electric vehicle charging systems have been developed. Such systems have a plurality of transmitters connected to each converter/inverter, and thus require fewer converters/inverters to be installed at the vehicle park, which can mitigate the above problems.

An example of a one-to-many system is described in WO 2022/258782. In this system, a capacitive cable is used to supply power from one converter/inverter to a plurality of transmitters. Capacitive cables are known in the art and are described in, for example, WO 2010/026380, WO 2019/234449, WO 2021/094783, WO 2021/094782, WO 2020/120932, and WO 2024/110610. Since capacitive cables typically exhibit much lower reactance than conventional cables, the power losses and voltage losses observed along the lengths of these cables when these cables are used to transmit power at a high frequency are reduced compared to using conventional cables instead. This means capacitive cables can be used to efficiently transfer power in the form of alternating current at a high frequency over distances much greater than 2-3 m, which can allow a plurality of transmitters to be connected to each converter/inverter, and thus the number of converters/inverters of the wireless electric vehicle charging system to be reduced compared to one-to-one systems having the same number of transmitters.

One-to-many wireless electric vehicle charging systems supply to each transmitter, and thus to the electric vehicles charging using the system, power having either (i) a fixed current and a variable voltage or (ii) a variable current and a fixed voltage. This means one-to-many wireless electric vehicle charging systems are suitable for charging electric vehicles having active rectifiers. An active rectifier is able to switch between being configured to receive power having (i) a fixed current and a variable voltage and (ii) a variable current and a fixed voltage, and can thus switch to whichever configuration is required when the electric vehicle the active rectifier forms part of parks at a vehicle park comprising a one-to-many wireless electric vehicle charging system.

Despite the above-mentioned advantages of one-to-many systems over one-to-one systems, one-to-many wireless electric vehicle charging systems have not previously been widely used. One reason for this is that prior art one-to-many systems are not suitable for charging electric vehicles having passive rectifiers, which are standardised by industry standards SAE J2954 and IEC 61980. This is because electric vehicles having passive rectifiers require a direct, one-to-one connection to the converter/inverter in order to be supplied with power thereby. The reason for this is that passive rectifiers do not control how power is supplied to them, i.e. they cannot switch between configurations unlike active rectifiers. Instead, the converter/inverter dynamically varies the voltage, current, and/or frequency of power supplied to the transmitter at which the electric vehicle having the passive rectifier is parked to vary the amount of power supplied to the electric vehicle. Thus, a one-to-one connection is necessary to enable the converter/inverter to specifically control the power output to the transmitter concerned.

Hence, prior art one-to-many wireless electric vehicle charging systems are suitable for charging electric vehicles having active rectifiers, but not electric vehicles having passive rectifiers. In contrast, vehicle parks comprising one-to-one wireless electric vehicle charging systems can be used to charge both electric vehicles having active rectifiers and electric vehicles having passive rectifiers. This is because some of the converters/inverters at the vehicle park may be configured to provide power having a fixed voltage and a variable current, whilst others can be configured to provide power having a variable voltage and a fixed current, and yet others can be configured to provide power having a dynamically variable voltage, current, and/or frequency. In each case, since there is only one transmitter connected to each converter/inverter, a direct, one-to-one connection between the converter/inverter and the rectifier of the electric vehicle is established. Electric vehicles entering the vehicle park can thus be directed to a transmitter connected to a converter/inverter configured to supply power in an appropriate form for the rectifier of that electric vehicle.

Since one-to-one wireless electric vehicle charging systems can be used to charge electric vehicles having passive rectifiers as well as those having active rectifiers, unlike one-to-many wireless electric vehicle charging systems, one-to-many systems have not become widely used, despite their advantages over one-to-one systems.

It is therefore desirable to provide a one-to-many wireless electric vehicle charging system which can be used to charge both electric vehicles having active rectifiers and electric vehicles having passive rectifiers.

It is also desirable in general to provide alternative, and preferably improved, wireless electric vehicle charging systems and components therefor.

### SUMMARY OF THE DISCLOSURE

The disclosure provides a one-to-many wireless electric vehicle charging system which can be used to charge electric vehicles having active rectifiers and electric vehicles having passive rectifiers. The disclosure also provides a power management system, a modular converter, a modular inverter, and a transmitter for use in such a wireless electric vehicle charging system, as well as use of such components in such a wireless electric vehicle charging system.

The disclosure additionally provides a vehicle park comprising the one-to-many wireless electric vehicle charging system, as well as a method of charging a battery of an electric vehicle parked at a transmitter of the one-to-many wireless electric vehicle charging system.

An advantage of the wireless electric vehicle charging system of the disclosure is that this can be used to charge both electric vehicles having active rectifiers and electric vehicles having passive rectifiers.

Another advantage of the wireless electric vehicle charging system of the disclosure is that the form of power provided to an electric vehicle at a particular transmitter can be changed, which means there may be less need, or possibly no need at all, to direct an electric vehicle to a parking space which has a transmitter configured to supply power in the appropriate form for that electric vehicle's rectifier. This can render the wireless electric vehicle charging system, as well as a vehicle park comprising such a system, more convenient for an operator of the system/park to manage. The method of the disclosure can be advantageous for corresponding reasons.

A third advantage of the wireless electric vehicle charging system of the disclosure is that this is a one-to-many system that can be used to establish a one-to-one connection between the converter/inverter thereof and a transmitter which is used to supply power to an electric vehicle having a rectifier that requires such a connection.

A fourth advantage of the wireless electric vehicle charging system of the disclosure is that this can be used to charge both electric vehicles configured to operate at 400 V and electric vehicles configured to operate at 800 V.

The power management system, modular converter, modular inverter, and transmitter of the disclosure are similarly advantageous because these can be used to help achieve the advantages of the wireless electric vehicle charging system mentioned above.

### BRIEF DESCRIPTION OF THE DRAWINGS

The disclosure is now illustrated by way of the following examples, with reference to the accompanying drawings, in which:

FIG. 1 shows a schematic block diagram of a wireless electric vehicle charging system;

FIG. 2 shows a schematic block diagram of the wireless electric vehicle charging system of FIG. 1 with four electric vehicles respectively parked at four transmitters;

FIG. 3 shows the wireless electric vehicle charging system of FIG. 2 after two of the electric vehicles have finished charging and have thus driven away;

FIG. 4 shows the wireless electric vehicle charging system of FIG. 3 after another electric vehicle has parked at one of the transmitters shown as vacant in FIG. 3;

FIG. 5 shows the wireless electric vehicle charging system of FIG. 4 after an electric vehicle has parked at the transmitter shown as vacant in FIG. 4; and

FIG. 6 shows the wireless electric vehicle charging system of FIG. 5 at a later time point than that shown in FIG. 5.

### DETAILED DESCRIPTION OF THE DISCLOSURE

According to a first aspect of the disclosure, there is provided a wireless electric vehicle charging system, comprising:
(a) a modular converter or modular inverter comprising a plurality of modules each configured to receive power from a power source and to output power in the form of alternating current,
(b) a plurality of transmitters each configured to receive power from the modular converter/inverter and to wirelessly transmit power,
   wherein each module is switchable between:
(i) a first module mode wherein the module is configured to output power to one of the transmitters via a cable connected to the one transmitter but not to the other transmitters, and
(ii) a second module mode wherein the module is configured to output power to one or more of the transmitters via a cable connected to all of the plurality of transmitters, and
   wherein each transmitter is switchable between:
(i) a first transmitter mode wherein the transmitter is configured to receive power from one of the modules, the module being in the first module mode, via the cable connected to the one transmitter but not to the other transmitters, and
(ii) a second transmitter mode wherein the transmitter is configured to receive power from one or more of the modules, each being in the second module mode, via the cable connected to all of the plurality of transmitters.

As used herein, the term “converter” is intended to mean an electrical component which is capable of converting alternating current having a first frequency to alternating current having a second frequency, the second frequency being different to the first frequency.

As used herein, the term “inverter” is intended to mean an electrical component which is capable of converting direct current to alternating current.

As used herein, the term “rectifier” is intended to mean an electrical component which is capable of converting alternating current to direct current.

It will be appreciated that the wireless electric vehicle charging system is a one-to-many wireless electric vehicle charging system because it comprises a plurality of transmitters configured to receive power from the same converter/inverter.

It will also be appreciated that when a module is in the first module mode, the transmitter it is configured to output power to will be in the first transmitter mode. Similarly, when a transmitter is in the first transmitter mode, the module it is configured to receive power from will be in the first module mode. Likewise, when a module is in the second module mode, the one or more transmitters it is configured to output power to will each be in the second transmitter mode and, when a transmitter is in the second transmitter mode, the one or more modules it is configured to receive power from will each be in the second module mode.

The transmitter may be a coil. Preferably, the transmitter is part of a ground pad of the wireless electric vehicle charging system, which may be integrated into a parking space of a vehicle park. Including the transmitter in a ground pad can be advantageous because one or more of the other components of the ground pad may protect the transmitter from damage caused by, for example, an electric vehicle driving over the transmitter.

The wireless electric vehicle charging system may comprise, for each transmitter individually, a cable connecting the transmitter to the converter/inverter. This can be advantageous because this may enable a one-to-one connection to be formed between the transmitter and a module of the converter/inverter, which may be required by certain types of electric vehicles, especially those having passive rectifiers. Thus, this can be advantageous because it may enable charging of electric vehicles which it has not previously been possible to charge using a one-to-many wireless electric vehicle charging system.

The cables connecting each transmitter individually to the converter/inverter may not connect each transmitter to a specific module of the converter/inverter. Instead, the cables may connect each transmitter to the converter/inverter generally, which may enable a specific module to be assigned to a particular transmitter when the wireless electric vehicle charging system is in use. In this context, “assignment” is intended to mean a process of switching a module to the first module mode such that it is then configured to output power to the particular transmitter via the cable connected to that transmitter but not to the other transmitters. Any one of the modules may be assigned to any one of the transmitters.

Each module in the second module mode may be configured to output power to all of the plurality of transmitters, each being in the second transmitter mode. Thus, all of the transmitters may be in the second transmitter mode at a given time, simultaneously drawing power from all of the modules in the second module mode via the cable connected to all of the plurality of transmitters. Thus, the cable connected to all of the plurality of transmitters may be a parallel distribution backbone cable configured to supply power to a plurality of transmitters simultaneously.

Each module in the second module mode may be configured to output power to a subset of the plurality of transmitters, each being in the second transmitter mode, wherein the other transmitter(s) is/are each in the first transmitter mode. Thus, some of the transmitters, i.e. those in the second transmitter mode, may draw power from the cable connected to all of the plurality of transmitters whilst others, i.e. those in the first transmitter mode, may each draw power specifically from one module of the modular converter/inverter. This can be advantageous because this may facilitate simultaneous charging of electric vehicles having active rectifiers and electric vehicles having passive rectifiers.

Each transmitter in the second transmitter mode may be configured to receive power from all of the plurality of modules, each being in the second module mode. Thus, all of the modules may be in the second module mode at a given time, simultaneously providing power to all of the transmitters in the second module mode via the cable connected to all of the plurality of transmitters. This can be advantageous because it may facilitate a combined power output of two or more modules being provided to the same transmitter, thus increasing the amount of power which an electric vehicle may otherwise be able to draw from the transmitter at a given time. This can be advantageous if an electric vehicle with a particular high power demand parks at one of the transmitters. For example, if each module is configured to output up to 10 kW of power, then the maximum amount of power a transmitter may be able to draw from the converter/inverter when in the first transmitter mode will be 10 kW. However, if two such modules are connected in parallel, i.e. both in the second module mode, then a transmitter drawing power from the cable connected to all of the plurality of transmitters, i.e. in the second transmitter mode, may be able to draw up to 20 kW of power at any given time. This is advantageous because this may facilitate faster charging of an electric vehicle parked at this transmitter compared to charging the electric vehicle using a module in the first module mode.

Each transmitter in the second transmitter mode may be configured to receive power from a subset of the plurality of modules, each being in the second module mode, wherein the other module(s) is/are each in the first module mode. Thus, some of the modules, i.e. those in the second module mode, may output power to the cable connected to all of the plurality of transmitters whilst others, i.e. those in the first module mode, may each output power specifically to one transmitter. This can be advantageous because this may facilitate simultaneous charging of electric vehicles having active rectifiers and electric vehicles having passive rectifiers.

The wireless electric vehicle charging system may comprise a power management system having:
(a) a receiver configured to receive data from one or more electric vehicle(s),
(b) a processor configured to determine, according to the data:
   (i) for each module individually, whether the module is required to operate in the first module mode or the second module mode, and
   (ii) for each transmitter individually, whether the transmitter is required to operate in the first transmitter mode or the second transmitter mode, and
(c) a controller configured to switch, according to the determination:
   (i) each module individually to the first module mode or the second module mode, and
   (ii) each transmitter individually to the first transmitter mode or the second transmitter mode.

Including such a power management system can be advantageous because this may enable the wireless electric vehicle charging system to switch the modules and the transmitters between modes according to requirements of one or more electric vehicle(s) charging using the system.

The data from the one or more electric vehicle(s) may be data about a charging requirement of each electric vehicle. For example, the charging requirement may comprise whether the electric vehicle has an active rectifier or a passive rectifier. Such embodiments can be advantageous because these may enable the wireless electric vehicle charging system to provide each electric vehicle with an appropriate amount of power in the appropriate form according to charging requirements of the electric vehicle.

Each of the one or more electric vehicle(s) may be an electric vehicle parked at, or approaching, one of the transmitters. Receiving data from an electric vehicle parked at one of the transmitters is advantageous because this may enable the system to be changed in response to a change in power demand at the transmitter. Receiving data from an electric vehicle approaching one of the transmitters is advantageous because this may enable the system to be changed in anticipation of a change in power demand at the transmitter that is about to occur, which may ensure the transmitter and converter/inverter are appropriately configured to charge the arriving electric vehicle by the time the vehicle has parked at the transmitter, which may, for example, facilitate faster charging of the electric vehicle once it parks at the transmitter.

Each module in the first module mode may be configured to output an amount of power to the one transmitter determined by the modular converter/inverter in response to a request by an electric vehicle parked at, or approaching, the one transmitter. This can be advantageous because certain types of rectifier requiring a one-to-one connection, such as passive rectifiers standardised by SAE J2954 and IEC 61980, may request an amount of power to be supplied by the wireless electric vehicle charging system, but the converter/inverter of the wireless electric vehicle charging system may ultimately decide whether to supply that amount of power or a different amount of power; it will be appreciated that, in such systems, the converter/inverter is the locus of control of power supply to the electric vehicle.

Each module in the second module mode may be configured to respectively output an amount of power to each of the one or more transmitter(s) requested by an electric vehicle parked at, or approaching, the transmitter. This can be advantageous because certain types of rectifier, such as active rectifiers, may request an amount of power to be supplied by the wireless electric vehicle charging system, and the converter/inverter may then supply that amount of power unless insufficient power is available, in which case the converter/inverter will typically supply as much power as is possible; it will be appreciated that, in such systems, the rectifier is the locus of control of power supply to the electric vehicle.

Each module in the first module mode may be configured to output power having a dynamically variable voltage, current, and/or frequency. This is advantageous because passive rectifiers configured to receive power in this form may require a direct, one-to-one connection to a particular module of the converter/inverter, which is achieved by using the module in this manner.

Each module in the first module mode may be configured to output power in the form of alternating current having a variable frequency. This is advantageous as this may provide an alternative way of controlling the amount of power supplied to a transmitter, i.e. without requiring the voltage and/or the current to be modified. This can provide an operator of the wireless electric vehicle charging system with a greater degree of control, such as by allowing the operator to select whichever electrical parameter is most convenient to modify and to then modify that parameter accordingly.

Each module in the second module mode may be configured to output power having (i) a fixed voltage and a variable current or (ii) a variable voltage and a fixed current. This can be advantageous because active rectifiers configured to receive power in one or these forms may not require a direct, one-to-one connection to a particular module of the converter/inverter, which means power can be drawn from the cable connected to all of the plurality of transmitters instead. This may allow a greater amount of power to be provided to a transmitter at which an electrical vehicle having such a rectifier has parked than may be possible using one of the modules in the first module mode.

Certain electric vehicles are configured to operate at 400 V, whilst others are configured to operate at 800 V. Thus, in embodiments wherein each module in the second module mode is configured to output power having a fixed voltage and a variable current, it may not be possible to charge both of these types of electric vehicle. For example, if the voltage is fixed at 400 V, then the modules in the second module mode may not be able to provide power to an electric vehicle configured to operate at 800 V that has parked at one of the transmitters. In such cases, the transmitter at which the 800 V electric vehicle has parked may be switched to the first transmitter mode and thus configured to receive power from a module in the first module mode; this module can be configured to output power at 800 V, as required by the electric vehicle. Thus, the wireless electric vehicle charging system is advantageous because this can be used to charge both electric vehicles configured to operate at 400 V and electric vehicles configured to operate at 800 V.

Each module may be configured to output power at a frequency of about 70 kHz to about 95 kHz. Preferably, each module is configured to output power at a frequency of about 85 kHz. These are suitable frequencies for generating a sufficiently large magnetic field around a transmitter for the transmitter to wirelessly transmit power to an electric vehicle parked at the transmitter.

If there are more transmitters than modules, then the number of transmitters that can receive power in the first transmitter mode is limited by the number of modules, since one module may be required to be in the first module mode for each transmitter in the first transmitter mode. Thus, preferably the wireless electric vehicle charging system comprises equal numbers of modules and transmitters. This allows any of the transmitters to draw power in the first transmitter mode or the second transmitter mode at any given time, and thus may provide an operator of the system with a greater degree of control and flexibility over how to configure the system according to requirements of electric vehicles using the system.

The modular converter/inverter may comprise at least two modules. Preferably, there are at least three modules. More preferably, there are at least four modules. Even more preferably, there are at least five modules. Yet even more preferably, there are at least six modules. Including a greater number of modules facilitates a greater degree of control for an operator of the wireless electric vehicle charging system, such as by allowing more modules to be switched to the first module mode at a given time. Additionally, this may facilitate a greater amount of power being supplied to a particular transmitter given that a combined power output of two or more modules in the second module mode may be supplied to one transmitter.

The wireless electric vehicle charging system may comprise at least two transmitters. More preferably, there are at least four transmitters. Even more preferably, there are at least five transmitters. Yet even more preferably, there are at least six transmitters. Using a greater number of transmitters facilitates charging of a greater number of electric vehicles.

Each module of the modular converter may be a converter, i.e. may be capable of converting alternating current having a first frequency to alternating current having a second frequency, the second frequency being different to the first frequency. Similarly, each module of the modular inverter may be an inverter, i.e. may be capable of converting direct current to alternating current.

Each module may be a power amplifier module.

The wireless electric vehicle charging system may comprise four modules each of which is a power amplifier module configured to output power of up to 10 kW. Thus, the modular converter/inverter may be a 40 kW converter/inverter. In such embodiments, up to 40 kW of power may be supplied to a transmitter at any given time, i.e. if all modules are in the second module mode and only one transmitter is in the second transmitter mode. It will be appreciated that if a transmitter is in the first transmitter mode then it may only receive up to 10 kW of power at any given time. Such embodiments can be advantageous as these are typical amounts of power required by electric vehicles charging at wireless electric vehicle charging stations installed at vehicle parks.

The wireless electric vehicle charging system may comprise six modules each of which is a power amplifier module configured to output power of up to 25 kW. Thus, the modular converter/inverter may be a 150 kW converter. In such embodiments, up to 150 kW of power may be supplied to a transmitter at any given time, i.e. if all modules are in the second module mode and only one transmitter is in the second transmitter mode. It will be appreciated that if a transmitter is in the first transmitter mode then it may only receive up to 25 kW of power at any given time. Such embodiments can be advantageous as these are typical amounts of power required by electric vehicles charging at wireless electric vehicle charging stations installed at vehicle parks.

The cable connected to the one transmitter but not to the other transmitters may be a capacitive cable having:
(a) a first conductor connected to the modular converter/inverter but not to the one transmitter,
(b) a second conductor connected to the one transmitter but not to the modular converter/inverter, and
(c) a dielectric material between the first conductor and the second conductor.

Using a capacitive cable can reduce the reactance of the cable compared to using a conventional cable, which may maximise the efficiency of the wireless electric vehicle charging system.

The cable connected to all of the plurality of transmitters may be a capacitive cable having:
(a) a first conductor connected to the modular converter/inverter but not to the plurality of transmitters,
(b) a second conductor connected to all of the plurality of transmitters but not to the modular converter/inverter, and
(c) a dielectric material between the first conductor and the second conductor.

Using a capacitive cable can reduce the reactance of the cable compared to using a conventional cable, which may maximise the efficiency of the wireless electric vehicle charging system. Additionally, this may facilitate connection of a plurality of transmitters to the same modular converter/inverter with reduced power loss and/or voltage loss along the length of the cable compared to using a conventional cable instead. Thus, using a capacitive cable may improve the ability of the wireless electric vehicle charging system to supply a desired amount of power to each transmitter compared to using a conventional cable instead.

The wireless electric vehicle charging system may comprise an impedance management system configured to modify an impedance of the cable connected to all of the plurality of transmitters. This can be advantageous because the impedance management system may be used to control the amount of current, and thus also the amount of power, supplied to each transmitter at a given time, since increasing the impedance of the capacitive cable may reduce the current, and thus the power, for example. This may allow the amount of current, and thus the amount of power, supplied to each transmitter to be changed over time, and thus such embodiments are particularly useful when the modules in the second module mode are configured to supply power having a fixed voltage and a variable current.

An example of a suitable impedance management system for use in the wireless electric vehicle charging system is described in PCT/EP2024/064946, the contents of which are hereby incorporated by reference in their entirety.

The impedance management system may be configured to modify an overall impedance of the cable or one or more local impedance(s) at one or more point(s) along the cable. Modifying the overall impedance of the cable can be advantageous because this may facilitate large-scale changes in the amount of current/power supplied to each transmitter. Modifying one or more local impedance(s) at one or more point(s) along the cable can be advantageous because this may facilitate fine tuning of the impedance at each transmitter, and thus of the current supplied to each transmitter. Additionally, modifying one or more local impedance(s) at one or more point(s) along the cable can enable a different amount of current/power to be supplied to each transmitter.

The one or more point(s) along the cable may each be associated with one of the transmitters. This can be advantageous because this may facilitate finer tuning of the impedance at each transmitter, and thus of the current/power supplied to each transmitter, compared to the one or more point(s) being associated with one or more other point(s) along the cable.

The wireless electric vehicle charging system may comprise a modular converter. In other words, preferably the modular converter or modular inverter is a modular converter.

According to a second aspect of the disclosure, there is provided a power management system for a wireless electric vehicle charging system according to the first aspect of the disclosure, comprising:
(a) a receiver for receiving data from one or more electric vehicle(s),
(b) a processor for determining, according to the data:
   (i) for each module of the wireless electric vehicle charging system individually, whether the module is required to operate in the first module mode or the second module mode, and
   (ii) for each transmitter of the wireless electric vehicle charging system individually, whether the transmitter is required to operate in the first transmitter mode or the second transmitter mode, and
(c) a controller configured to switch, according to the determination:
   (i) each module individually to the first module mode or the second module mode, and
   (ii) each transmitter individually to the first transmitter mode or the second transmitter mode.

Such a power management system enables a wireless electric vehicle charging system in which the power management system is used to switch the modules and the transmitters thereof between modes according to requirements of one or more electric vehicle(s) charging using the system.

The data from the one or more electric vehicle(s) may be data about a charging requirement of each electric vehicle. For example, the charging requirement may comprise whether the electric vehicle has an active rectifier or a passive rectifier. Such embodiments can be advantageous because these may enable a wireless electric vehicle charging system in which the power management system is used to provide each electric vehicle with an appropriate amount of power in the appropriate form according to charging requirements of the electric vehicle.

Each of the one or more electric vehicle(s) may be an electric vehicle parked at, or approaching, one of the transmitters of the wireless electric vehicle charging system. Receiving data from an electric vehicle parked at one of the transmitters can be advantageous because this may enable the system to be changed in response to a change in power demand at the transmitter. Receiving data from an electric vehicle approaching one of the transmitters enables the system to be changed in anticipation of a change in power demand at the transmitter that is about to occur, which may ensure the transmitter and converter/inverter are appropriately configured to charge the arriving electric vehicle by the time the vehicle has parked at the transmitter, which may, for example, facilitate faster charging of the electric vehicle once it parks at the transmitter.

According to a third aspect of the disclosure, there is provided a modular converter or modular inverter for a wireless electric vehicle charging system according to the first aspect of the disclosure, comprising a plurality of modules each for receiving power from a power source and for outputting power in the form of alternating current, wherein each module is switchable between:
(i) a first module mode wherein the module is for outputting power to a transmitter via a cable connected to the transmitter but not to any other transmitters, and
(ii) a second module mode wherein the module is for outputting power to one or more transmitters via a cable connected to each of a plurality of transmitters.

Such a modular converter/inverter helps achieve the above-mentioned advantages of the wireless electric vehicle charging system.

Preferably, the modular converter or modular inverter is a modular converter. Such a modular converter can be advantageous because the power source/supply configured to supply power to the converter/inverter is typically configured to supply power in the form of alternating current at a frequency of about 50 Hz or about 60 Hz, rather than in the form of direct current, because this is the form of power supplied by typical electrical grids in, for example, the UK and the USA. Thus, a converter is typically able to process this alternating current input, whereas an inverter may not be.

According to a fourth aspect of the disclosure, there is provided a transmitter for a wireless electric vehicle charging system according to the first aspect of the disclosure, wherein the transmitter is for receiving power from a modular converter or modular inverter and for wirelessly transmitting power, and wherein the transmitter is switchable between:
(i) a first transmitter mode wherein the transmitter is for receiving power from a module of the modular converter/inverter via a cable connected to the transmitter but not to any other transmitters, and
(ii) a second transmitter mode wherein the transmitter is for receiving power from one or more modules of the modular converter/inverter via a cable connected to each of a plurality of transmitters.

Such a transmitter helps achieve the above-mentioned advantages of the wireless electric vehicle charging system.

According to a fifth aspect of the disclosure, there is provided a vehicle park comprising a wireless electric vehicle charging system according to the first aspect of the disclosure. Preferably, the vehicle park is a car park. It will be appreciated that the above-described advantages of the wireless electric vehicle charging system apply equally to the vehicle/car park. However, the vehicle/car park can additionally be advantageous because each transmitter may be installed in a parking space, such as at a centre of the parking space, which can ensure an electric vehicle parks in an appropriate position to be charged by the wireless electric vehicle charging system. For example, by parking the electric vehicle in a clearly marked parking space, it can be ensured that a receiver in the electric vehicle for receiving power from the transmitter is well-aligned with the transmitter, thereby facilitating efficient charging of the electric vehicle.

According to a sixth aspect of the disclosure, there is provided use of a power management system according to the second aspect of the disclosure in a wireless electric vehicle charging system according to the first aspect of the disclosure. It will be appreciated that this can be advantageous for corresponding reasons to those given above in relation to the first and second aspects of the disclosure.

According to a seventh aspect of the disclosure, there is provided use of a modular converter or modular inverter according to the third aspect of the disclosure in a wireless electric vehicle charging system according to the first aspect of the disclosure. It will be appreciated that this can be advantageous for corresponding reasons to those given above in relation to the first and third aspects of the disclosure.

According to an eighth aspect of the disclosure, there is provided use of a transmitter according to the fourth aspect of the disclosure in a wireless electric vehicle charging system according to the first aspect of the disclosure. It will be appreciated that this can be advantageous for corresponding reasons to those given above in relation to the first and fourth aspects of the disclosure.

According to a ninth aspect of the disclosure, there is provided a method of charging a battery of an electric vehicle parked at a transmitter of a wireless electric vehicle charging system according to the first aspect of the disclosure, comprising:
(a) receiving data from the electric vehicle,
(b) determining, according to the data:
   (i) for each module of the wireless electric vehicle charging system individually, whether the module is required to operate in the first module mode or the second module mode,
   (ii) whether the transmitter is required to operate in the first transmitter mode or the second transmitter mode, (c) switching, according to the determination:
   (i) each module individually to the first module mode or the second module mode, and
   (ii) the transmitter to the first transmitter mode or the second transmitter mode,
(d) outputting power from the modular converter/inverter of the wireless electric vehicle charging system to the transmitter,
(e) wirelessly transmitting power from the transmitter to the electric vehicle, and
(f) using the power transmitted to the electric vehicle to charge a battery of the electric vehicle.

Such a method can be advantageous because this can ensure the electric vehicle is provided with power in a form appropriate for its rectifier.

The data from the electric vehicle may be data about a charging requirement of the electric vehicle. For example, the charging requirement may comprise whether the electric vehicle has an active rectifier or a passive rectifier. Such embodiments can be advantageous because these may enable the method to provide the electric vehicle with an appropriate amount of power in the appropriate form according to charging requirements of the electric vehicle.

According to a tenth aspect of the disclosure, there is provided a (one-to-many) wireless electric vehicle charging system for supplying power to one or more electric vehicle(s) having different types of onboard charger, such as an onboard configured to (only) receive a direct current input from a rectifier (separate to the onboard charger) and an onboard charger configured to receive a high frequency alternating current input.

The wireless electric vehicle charging system may comprise a plurality of ground pads (or charging points). Preferably, one or more of the ground pads or charging points is/are configured to switch between receiving power from a converter separately to the other ground pad(s) and receiving power in parallel with the other ground pad(s).

The wireless electric vehicle charging system may be configured to supply power individually to a particular ground pad or charging point when an electric vehicle having an onboard charger configured to (only) receive a direct current input from a rectifier (separate to the onboard charger) is parked at or near the ground pad and/or to supply power to one or more ground pad(s), such as in parallel when an electric vehicle having an onboard charger configured to receive a high frequency alternating current input is parked at or near the ground pad.

### EXAMPLES

### Example 1—Structure of a Wireless Electric Vehicle Charging System

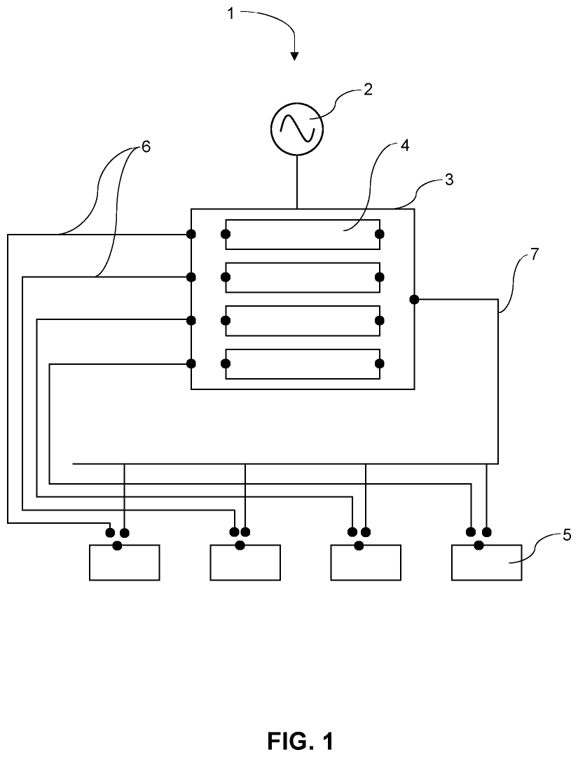

Referring to FIG. 1, a wireless electric vehicle charging system 1 comprises a power source 2 configured to output power at a frequency of 50 Hz and a modular converter 3. The converter comprises four power amplifier modules 4 each configured to receive power from the power source and to output power in the form of alternating current at a nominal frequency of 85 kHz. Each power amplifier is configured to output power of up to 10 kW, and thus the modular converter as a whole is configured to output power of up to 40 kW.

The wireless electric vehicle charging system additionally comprises four transmitters 5 each configured to receive power from the modular converter and to wirelessly transmit power.

Each power amplifier module is switchable between a first module mode wherein the module is configured to output power to one of the transmitters via a cable 6 connected to the one transmitter but not to the other transmitters, and a second module mode wherein the module is configured to output power to one or more of the transmitters via a cable 7 connected to all of the transmitters.

Each transmitter is switchable between a first transmitter mode wherein the transmitter is configured to receive power from one of the power amplifier modules, the power amplifier module being in the first module mode, via the cable connected to the one transmitter but not to the other transmitters, and a second transmitter mode wherein the transmitter is configured to receive power from one or more of the power amplifier modules, each being in the second module mode, via the cable connected to all of the plurality of transmitters.

To aid clarity, the structures of the cables each connected to one transmitter but not to the other transmitters are not shown in FIG. 1. However, each of these cables is a capacitive cable having a first conductor connected to the modular converter but not to the one transmitter, a second conductor connected to the one transmitter but not to the modular converter, and a dielectric material between the first conductor and the second conductor.

Similarly, to aid clarity, the structure of the cable connected to all of the plurality of transmitters is not shown in FIG. 1. However, this cable is a capacitive cable having a first conductor connected to the modular converter but not to the plurality of transmitters, a second conductor connected to all of the plurality of transmitters but not to the modular converter, and a dielectric material between the first conductor and the second conductor.

The wireless electric vehicle charging system additionally comprises an impedance management system (not shown in FIG. 1) configured to modify an impedance of the cable connected to all of the plurality of transmitters and a power management system (not shown in FIG. 1) having a receiver configured to receive data from one or more electric vehicle(s), a processor configured to determine, according to the data, for each module individually, whether the module is required to operate in the first module mode or the second module mode, and for each transmitter individually, whether the transmitter is required to operate in the first transmitter mode or the second transmitter mode, and a controller configured to switch, according to the determination, each module individually to the first module mode or the second module mode, and each transmitter individually to the first transmitter mode or the second transmitter mode.

In FIG. 1, only the components of the electrical circuit used to supply power from the power source to the transmitters are shown. However, it will be appreciated that a return line, such as a cable, is used to return power from the transmitters to the power source to complete the electrical circuit.

The wireless electric vehicle charging system is installed at a vehicle park, with each transmitter being installed in a centre of a parking space of the vehicle park.

### Example 2—Use of the Wireless Electric Vehicle Charging System of Example 1

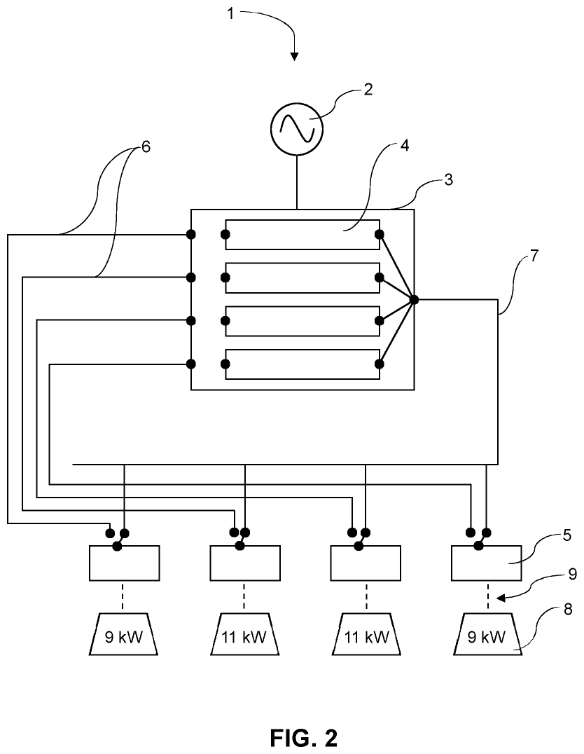

Referring to FIG. 2, the wireless electric vehicle charging system of Example 1 is shown with four electric vehicles 8 respectively parked at each of the four transmitters. Each electric vehicle is drawing power from its respective transmitter via wireless power transfer 9. All of the four electric vehicles have active rectifiers. Thus, all four of the power amplifier modules are switched to the second module mode and all four of the transmitters are switched to the second transmitter mode. Two of the electric vehicles have greater power demands than the other two electric vehicles and thus are each drawing 11 kW of power from the converter, whereas the other two electric vehicles are drawing only 9 kW of power each.

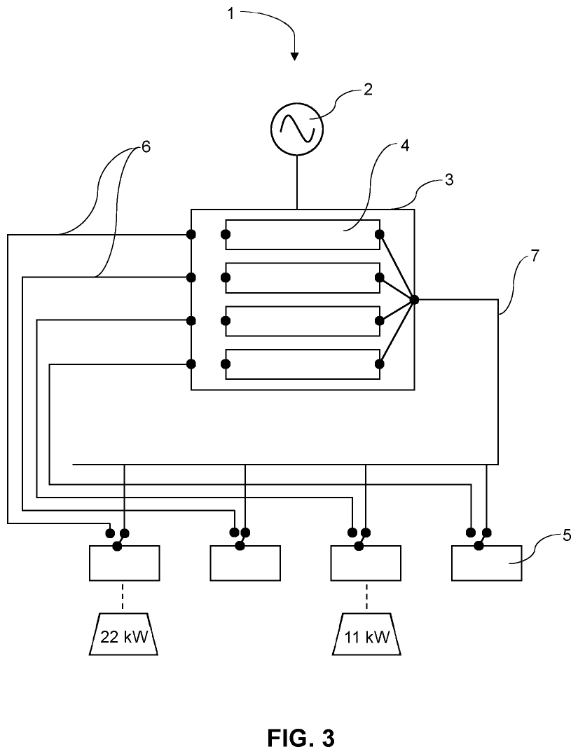

FIG. 3 shows the wireless electric vehicle charging system of FIG. 2 at a later timepoint than that shown in FIG. 2. Thus, referring to FIG. 3, two of the electric vehicles shown in FIG. 2 have finished charging and have thus driven away. This means there is more power available to be supplied to the two transmitters at which electric vehicles remain parked, and thus the power output to one of these transmitters has been increased from 9 kW to 22 kW, whilst the other electric vehicle continues to draw 11 kW of power from the converter. All four power amplifier modules remain in the second module mode and all four transmitters remain in the second transmitter mode.

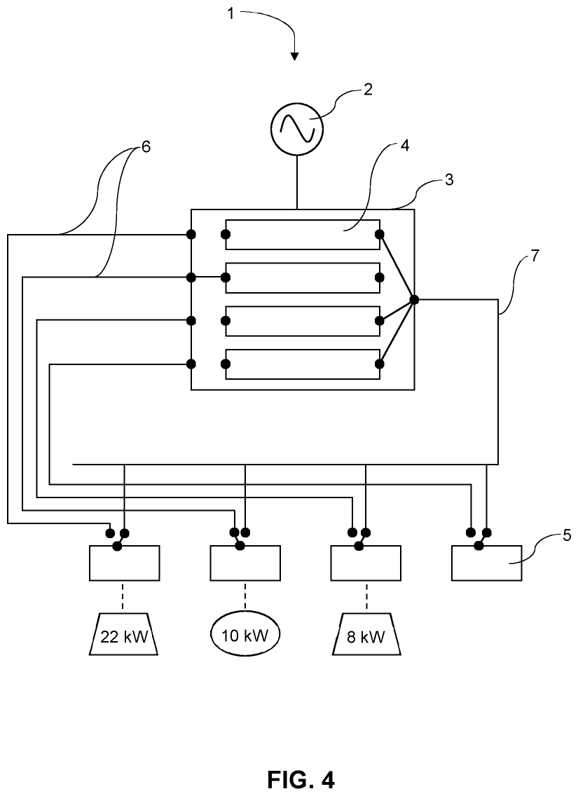

FIG. 4 shows the wireless electric vehicle charging system of FIG. 3 at a later timepoint than that shown in FIG. 3. Thus, referring to FIG. 4, an electric vehicle having a passive rectifier has parked at one of the transmitters previously shown as vacant in FIG. 3. This passive rectifier requires a one-to-one connection between the transmitter it is drawing power from and the modular converter, and thus one of the power amplifier modules is assigned to the transmitter at which this electric vehicle has parked. Thus, this power amplifier module is switched by the power management system to the first module mode and this transmitter is switched by the power management system to the first transmitter mode (see the switched connection on the transmitter at which the second-from-left, 10 kW vehicle is parked). The other power amplifier modules each remain in the second module mode and the other transmitters each remain in the second transmitter mode. The electric vehicle that has joined in FIG. 4 draws power at 10 kW, i.e. the maximum power output of the power amplifier module assigned to its transmitter, leaving 30 kW available for the other two electric vehicles. Thus, one of those vehicles continues to draw 22 kW of power, whilst the other now only draws 8 kW of power, whereas it was previously drawing 11 kW of power.

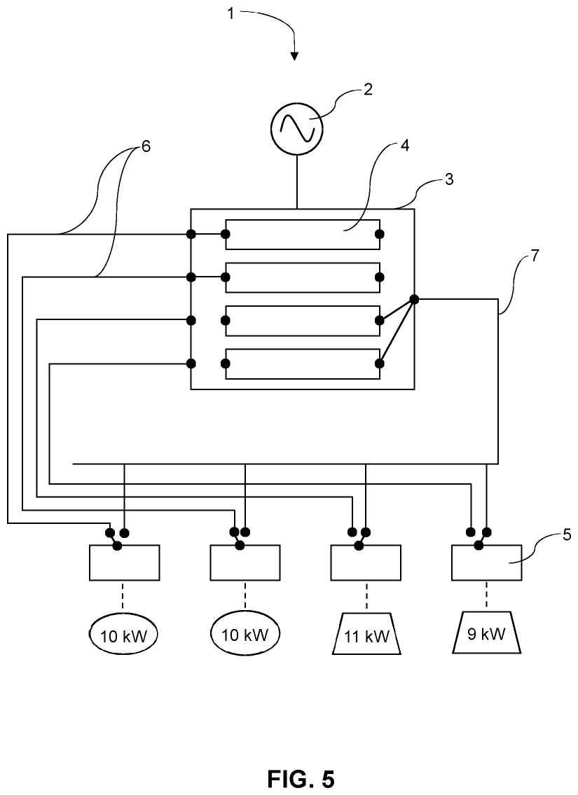

FIG. 5 shows the wireless electric vehicle charging system of FIG. 4 at a later timepoint than that shown in FIG. 4. Thus, referring to FIG. 5, the electric vehicle that was drawing power at 22 kW has finished charging and has thus driven away. Since then, a new electric vehicle having a passive rectifier has parked at its transmitter. This passive rectifier requires a one-to-one connection between the transmitter it is drawing power from and the modular converter, and thus one of the power amplifier modules is assigned to the transmitter at which this electric vehicle has parked. Thus, this power amplifier module is switched by the power management system to the first module mode and this transmitter is switched by the power management system to the first transmitter mode (see the switched connection on the furthest left transmitter).

Again referring to FIG. 5, an electric vehicle having an active rectifier has parked at the transmitter shown as vacant in FIG. 4. This transmitter is therefore kept in the second transmitter mode.

Each of the electric vehicles charging at a transmitter in the first transmitter mode draws 10 kW of power from the converter, leaving 20 kW of power for the other two transmitters. Thus, one of the other electric vehicles draws 11 kW of power and the other draws 9 kW of power.

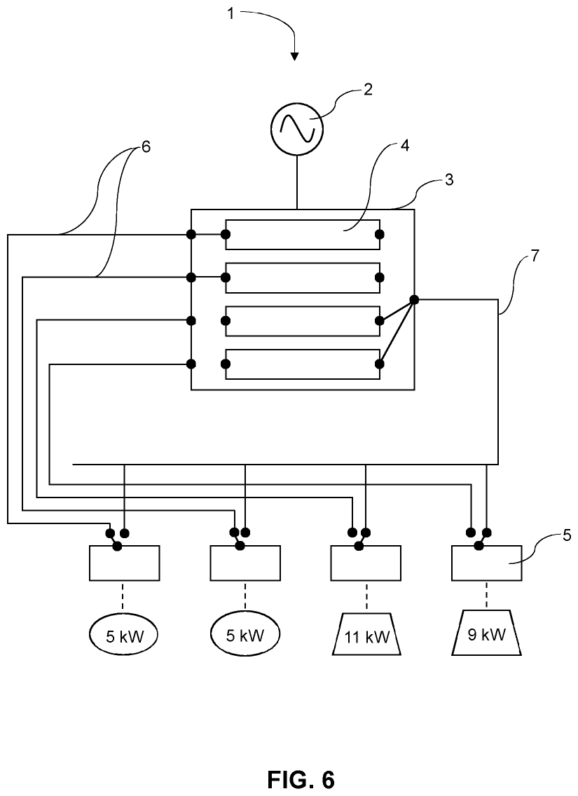

FIG. 6 shows the wireless electric vehicle charging system of FIG. 5 at a later timepoint than that shown in FIG. 5. Referring to FIG. 6, both of the electric vehicles charging at transmitters in the first transmitter mode have almost finished charging, so the amount of power they each draw from the system is decreased from 10 kW to 5 kW. However, this does not enable the amount of power supplied to the other two electric vehicles to be increased because the power amplifier modules each in the first module mode are not configured to output the remaining 5 kW of power they could each otherwise provide to the cable connected to all of the plurality of transmitters while in the first module mode. Thus, the two electric vehicles drawing 11 kW of power and 9 kW of power, respectively, continue to draw these amounts of power from the wireless electric vehicle charging system.

Accordingly, the wireless electric vehicle charging system is used to charge both electric vehicles having active rectifiers and electric vehicles having passive rectifiers.

### PARTS LIST

1 wireless electric vehicle charging system
2 power source
3 modular converter
4 power amplifier module
5 transmitter
6 cable connected to one transmitter
7 cable connected to all of a plurality of transmitters
8 electric vehicle
9 wireless power transfer

1. A wireless electric vehicle charging system, comprising:
(a) a modular converter or modular inverter comprising a plurality of modules each configured to receive power from a power source and to output power in the form of alternating current,
(b) a plurality of transmitters each configured to receive power from the modular converter/inverter and to wirelessly transmit power; and
(c) a plurality of cables,
wherein each module is switchable between:
(i) a first module mode wherein the module is configured to output power to one of the transmitters via one of the cables, the cable being connected to the one transmitter but not to the other transmitters; and
(ii) a second module mode wherein the module is configured to output power to one or more of the transmitters via one of the cables, the cable being connected to all of the plurality of transmitters, and
wherein each transmitter is switchable between:
(i) a first transmitter mode wherein the transmitter is configured to receive power from one of the modules, the module being in the first module mode, via the cable connected to the one transmitter but not to the other transmitters; and
(ii) a second transmitter mode wherein the transmitter is configured to receive power from one or more of the modules, each being in the second module mode, via the cable connected to all of the plurality of transmitters.

2. The wireless electric vehicle charging system as claimed in claim 1, wherein:
(i) each module in the second module mode is configured to output power to all of the plurality of transmitters, each being in the second transmitter mode; and
(ii) each transmitter in the second transmitter mode is configured to receive power from all of the plurality of modules, each being in the second module mode.

3. The wireless electric vehicle charging system as claimed in claim 1, wherein;
(i) each module in the second module mode is configured to output power to a subset of the plurality of transmitters, each being in the second transmitter mode, and wherein the other transmitter(s) is/are each in the first transmitter mode; and
(ii) each transmitter in the second transmitter mode is configured to receive power from a subset of the plurality of modules, each being in the second module mode, and wherein the other module(s) is/are each in the first module mode.

4-5. (canceled)

6. The wireless electric vehicle charging system as claimed in claim 1, comprising a power management system having:
(a) a receiver configured to receive data from one or more electric vehicle(s);
(b) a processor configured to determine, according to the data:
(i) for each module individually, whether the module is required to operate in the first module mode or the second module mode, and
(ii) for each transmitter individually, whether the transmitter is required to operate in the first transmitter mode or the second transmitter mode, and
(c) a controller configured to switch, according to the determination:
(i) each module individually to the first module mode or the second module mode, and
(ii) each transmitter individually to the first transmitter mode or the second transmitter mode.

7. The wireless electric vehicle charging system as claimed in claim 4, wherein the data from the one or more electric vehicle(s) are data about a charging requirement of each electric vehicle.

8. The wireless electric vehicle charging system as claimed in claim 5, wherein the charging requirement comprises whether the electric vehicle has an active rectifier or a passive rectifier.

9. (canceled)

10. The wireless electric vehicle charging system as claimed in claim 1, wherein each module in the first module mode is configured to output an amount of power to the one transmitter determined by the modular converter/inverter in response to a request by an electric vehicle parked at, or approaching, the one transmitter.

11. The wireless electric vehicle charging system as claimed in claim 1, wherein each module in the second module mode is configured to respectively output an amount of power to each of the one or more transmitter(s) requested by an electric vehicle parked at, or approaching, the transmitter.

12. The wireless electric vehicle charging system as claimed in claim 1, wherein each module in the first module mode is configured to output power having a dynamically variable voltage, current, and/or frequency.

13. The wireless electric vehicle charging system as claimed in claim 1, wherein each module in the first module mode is configured to output power in the form of alternating current having a variable frequency.

14. The wireless electric vehicle charging system as claimed in claim 1, wherein each module in the second module mode is configured to output power having (i) a fixed voltage and a variable current or (ii) a variable voltage and a fixed current.

15-23. (canceled)

24. The wireless electric vehicle charging system as claimed in claim 1, wherein the cable connected to the one transmitter but not to the other transmitters is a capacitive cable having:
(a) a first conductor connected to the modular converter/inverter but not to the one transmitter;
(b) a second conductor connected to the one transmitter but not to the modular converter/inverter; and
(c) a dielectric material between the first conductor and the second conductor.

25. The wireless electric vehicle charging system as claimed in claim 1, wherein the cable connected to all of the plurality of transmitters is a capacitive cable having:
(a) a first conductor connected to the modular converter/inverter but not to the plurality of transmitters;
(b) a second conductor connected to all of the plurality of transmitters but not to the modular converter/inverter; and
(c) a dielectric material between the first conductor and the second conductor.

26. The wireless electric vehicle charging system as claimed in claim 13, comprising an impedance management system configured to modify an impedance of the cable connected to all of the plurality of transmitters.

27-29. (canceled)

30. A power management system for the wireless electric vehicle charging system as claimed in claim 4, comprising:
(a) a receiver for receiving data from one or more electric vehicle(s),
(b) a processor for determining, according to the data:
(i) for each module of the wireless electric vehicle charging system individually, whether the module is required to operate in the first module mode or the second module mode, and
(ii) for each transmitter of the wireless electric vehicle charging system individually, whether the transmitter is required to operate in the first transmitter mode or the second transmitter mode; and
(c) a controller configured to switch, according to the determination:
(i) each module individually to the first module mode or the second module mode, and
(ii) each transmitter individually to the first transmitter mode or the second transmitter mode.

31-33. (canceled)

34. A modular converter or modular inverter for the wireless electric vehicle charging system as claimed in claim 1, comprising a plurality of modules each for receiving power from a power source and for outputting power in the form of alternating current, wherein each module is switchable between:
(i) a first module mode wherein the module is for outputting power to a transmitter via a cable connected to the transmitter but not to any other transmitters, and
(ii) a second module mode wherein the module is for outputting power to one or more transmitters via a cable connected to each of a plurality of transmitters.

35-36. (canceled)

37. A vehicle park, comprising a wireless electric vehicle charging system as claimed claim 1.

38-40. (canceled)

41. A method of using a transmitter in the wireless electric vehicle charging system as claimed in claim 1, wherein the transmitter is for receiving power from a modular converter or modular inverter and for wirelessly transmitting power, and wherein the transmitter is switchable between:
(i) a first transmitter mode wherein the transmitter is for receiving power from a module of the modular converter/inverter via a cable connected to the transmitter but not to any other transmitters, and
(ii) a second transmitter mode wherein the transmitter is for receiving power from one or more modules of the modular converter/Inverter via a cable connected to each of a plurality of transmitters.

42. A method of charging a battery of an electric vehicle parked at a transmitter of the wireless electric vehicle charging system as claimed in claim 1, comprising:
(a) receiving data from the electric vehicle;
(b) determining, according to the data:
(i) for each module of the wireless electric vehicle charging system individually, whether the module is required to operate in the first module mode or the second module mode,
(ii) whether the transmitter is required to operate in the first transmitter mode or the second transmitter mode;
(c) switching, according to the determination:
(i) each module individually to the first module mode or the second module mode, and
(ii) the transmitter to the first transmitter mode or the second transmitter mode;
(d) outputting power from the modular converter/inverter of the wireless electric vehicle charging system to the transmitter;
(e) wirelessly transmitting power from the transmitter to the electric vehicle; and
(f) using the power transmitted to the electric vehicle to charge a battery of the electric vehicle.

43-44. (canceled)
